(19) United States
(12) Patent Application Publication
(10) Pub. No.: US 2019/0035514 A1
(43) Pub. Date: Jan. 31, 2019

(54) IMPREGNABLE ELECTRICAL INSULATING PAPER AND METHOD FOR PRODUCING ELECTRICAL INSULATING PAPER

(71) Applicant: Siemens Aktiengesellschaft, Munich (DE)

(72) Inventors: Andrey Mashkin, Köln (DE); Mario Brockschmidt, Essen (DE); Friedhelm Pohlmann, Essen (DE)

(73) Assignee: Siemens Aktiengesellschaft, Munich (DE)

(21) Appl. No.: 15/759,594

(22) PCT Filed: Sep. 1, 2016
(86) PCT No.: PCT/EP2016/070571

§ 371 Date: Mar. 13, 2018

(30) Foreign Application Priority Data
Sep. 29, 2015 (EP) 15187414.6

(51) Int. Cl. H01B 3/10; H01B 19/00

(52) U.S. Cl. CPC H01B 3/10; H01B 19/00

(57) ABSTRACT

An impregnable electrical insulating paper for an electrical insulating body having first platelet-shaped particles which have layer silicates, and second platelet-shaped particles which have a heat conductivity at 20° C. of at least 1 W/mK. A method for producing an impregnable electrical insulating paper, an electrical insulating tape, an electrical insulating body, and the use of the electrical insulating body having first platelet-shaped particles which have layer silicates, and second platelet-shaped particles.

### CROSS REFERENCE TO RELATED APPLICATIONS

This application is the US National Stage of International Application No. PCT/EP2016/070571 filed 1 Sep. 2016, and claims the benefit thereof. The International Application claims the benefit of European Application No. EP15187414 filed 29 Sep. 2015. All of the applications are incorporated by reference herein in their entirety.

### FIELD OF INVENTION

The invention relates to an impregnable electrical insulating paper for an electrical insulating body, a method for producing an electrical insulating paper, an electrical insulating tape, an electrical insulating body, and the use of the electrical insulating body.

### BACKGROUND OF INVENTION

Electrical high-voltage rotation machines, for example generators, comprise electrical conductors, a main insulation, and a stator core. The main insulation has the purpose of permanently insulating the electrical conductors from one another, from the stator core, and from the surroundings. During operation of the machines, electrical partial discharges occur, which result in the formation of so-called “treeing” channels in the main insulation. Due to the “treeing” channels, the main insulation then has only reduced electrical carrying capacity and an electrical breakdown of the main insulation can occur. A barrier against the partial discharges is achieved by the use of an electrical insulating tape. The electrical insulating tape has an electrical insulating paper, for example, a mica paper, which is applied to a carrier. Mica has a very high partial discharge resistance and thus suppresses the formation of the “treeing” channels.

In the production of mica paper, mica in the form of flaky mica particles having a conventional particle size of several hundred micrometers is used. The flaky mica particles are arranged in layers, so that the particles are arranged substantially parallel to one another.

The main insulation also assumes the task, in particular in generators, such as turbo-generators and hydroelectric generators, of heat transportation in addition to the electrical insulation. However, mica has the disadvantage that it only has a low thermal conductivity. The main insulation therefore also only has a low thermal conductivity. The thermal design of the generators takes the thermal conductivity of the main insulation into consideration, and so the low thermal conductivity limits the power of the generators. An increase of the thermal conductivity of the electrical insulating paper and therefore also of the thermal conductivity of the main insulation is therefore of interest.

### SUMMARY OF INVENTION

An object of the invention is to provide an electrical insulating paper for an electrical insulating body and a method for producing an electrical insulating paper, wherein the electrical insulating paper has a high thermal conductivity.

The electrical insulating paper according to the invention is an impregnable electrical insulating paper for an electrical insulating body, comprising first flaky particles, which comprise layered silicates, and second flaky particles, which have a thermal conductivity at 20° C. of at least 1 W/mK.

The electrical insulating paper is impregnable, i.e., it is not yet impregnated and can be impregnated. For this purpose, the electrical insulating paper has intermediate spaces between the particles, for example in the form of pores, into which an impregnating resin can penetrate upon impregnation. The structure of the electrical insulating paper is thus such that the impregnating resin can impregnate the electrical insulating paper.

The inventors have determined that an electrical insulating paper can have at least two different types of flaky particles, namely the first and the second particles, and an electrical insulating paper having improved properties is thus provided. The electrical insulating paper according to the invention not only has a high partial discharge resistance, but rather simultaneously also a high thermal conductivity.

The first flaky particles comprise layered silicates. The layered silicates advantageously comprise mica and/or bentonite. Layered silicates have a high resistance to electrical partial discharges. A particularly high partial discharge resistance is provided to the electrical insulating paper and the electrical insulating body by the use of layered silicates in the electrical insulating paper. The service life of the electrical insulating body is thus lengthened.

The second particles are also flaky. The second particles may thus be arranged together with the first particles in the electrical insulating paper in a simple manner. In this case, both the first and also the second particles contribute to the structure of the electrical insulating paper. The basic structure of the electrical insulating paper is thus formed by the first particles and the second particles.

The second particles have a thermal conductivity at 20° C. of at least 1 W/mK. Layered silicates only have a low thermal conductivity. For mica at 20° C., for example, it is approximately 0.2-0.25 W/mK. In contrast thereto, the second particles have a high thermal conductivity. Due to the presence of the second particles, the electrical insulating paper has a high thermal conductivity.

Due to the combination of the first particles with the second particles, the electrical insulating paper according to the invention has a high partial discharge resistance and a high thermal conductivity.

The use of the electrical insulating paper according to the invention in an electrical insulating body reduces temperature gradients in the electrical insulating body and provides the electrical insulating body with a high thermal conductivity. A higher degree of freedom in the thermal design of electrical high-voltage rotation machines, for example generators, is thus enabled. The performance and utilization of the machines may thus advantageously be increased.

The inventors have additionally established that the electrical insulating paper has a longer service life in comparison to a conventional electrical insulating paper comprising only one type of particles.

In one embodiment, the first particles comprise mica. The first particles are advantageously uncoated mica particles, i.e., they consist completely of mica. The first particles can also be coated mica particles, for example. The coated mica particles can be, for example, organophilized, in particular silanized mica particles. Mica has a very high resistance to electrical partial discharges.

In one embodiment, the second particles are provided in a sufficiently high volume proportion in relation to the electrical insulating paper that the second particles are in touch contact with one another and a network is thus formed from the second particles, which connects the two opposing sides of the electrical insulating paper to one another. The term “opposing sides” relates to the broad sides of the electrical insulating paper, i.e., to the two opposing sides which have a larger surface in comparison to the remaining two sides of the electrical insulating paper.

The network which connects the two opposing sides of the electrical insulating paper to one another is a coherent structure, which constructs a continuous connection between the two opposing sides of the electrical insulating paper. The volume proportion of the second particles in relation to the electrical insulating paper has to be sufficiently high, for this purpose, that the second particles come close enough to one another by random arrangement that they are in touch contact with one another in the electrical insulating paper.

The connection of the opposing sides of the electrical insulating paper formed by the network extends essentially perpendicularly to the plane of the paper of the electrical insulating paper through the electrical insulating paper. The connection thus leads from one broad side of the electrical insulating paper to the opposing broad side of the electrical insulating paper. Because of the high thermal conductivity of the second particles, the connection advantageously results in an improved transportation of heat through the electrical insulating paper.

In one embodiment, the second particles are provided in a volume proportion in relation to the electrical insulating paper of 5-80 vol. %, advantageously 25-80 vol. %, particularly advantageously 50-80 vol. %.

The term “volume proportion in relation to the electrical insulating paper” relates to the volume proportion of the particles in relation to the volume of the electrical insulating paper as a whole, wherein the volume of the electrical insulating paper as a whole also comprises the intermediate spaces between the particles. The higher the volume proportion of the second particles in relation to the electrical insulating paper, the better heat can be conducted through the electrical insulating paper.

In one embodiment, the second particles are arranged on the two opposing sides of the electrical insulating paper and are in touch contact with one another, whereby a network is formed from the second particles on the two opposing sides of the electrical insulating paper.

The network on the two opposing sides of the electrical insulating paper is a coherent structure, which constructs a continuous connection along each of the two opposing sides of the electrical insulating paper. The volume proportion of the second particles in relation to the electrical insulating paper has to be sufficiently high, for this purpose, that the second particles come close enough to one another by random arrangement on the two opposing sides of the electrical insulating paper that they are in touch contact with one another.

The connection formed by the network on the opposing sides of the electrical insulating paper extends essentially parallel to the plane of the paper of the electrical insulating paper. Because of the high thermal conductivity of the second particles, the connection advantageously results in improved transportation of heat along the two opposing sides of the electrical insulating paper.

In one embodiment, the thermal conductivity of the second particles at 20° C. is at least 2 W/mK, advantageously at least 10 W/mK, particularly advantageously at least 25 W/mK. A particularly high thermal conductivity of the electrical insulating paper is thus achieved.

In one embodiment, the second particles have a particle size of at least 5 nm and at most 150 μm, advantageously at least 5 μm and at most 150 μm, particularly advantageously at least 50 μm and at most 150 μm.

The particle size is the longest dimension of the particle in this case. The particle size of the second particles has an influence on the extent to which the second particles participate, in addition to the first particles, in the structure of the electrical insulating paper. The inventors have established that second particles which have a particle size of at least 5 μm and at most 150 μm are particularly suitable for, together with the first particles, forming the basic structure of the electrical insulating paper and thus constructing the electrical insulating paper. A high strength of the electrical insulating paper is thus achieved, while conventional mica paper only has a low strength.

Second particles which have a particle size of at least 50 μm and at most 150 μm are most suitable for constructing the electrical insulating paper together with the first particles. Moreover, a particularly high strength of the electrical insulating paper is achieved using these second particles.

In one embodiment, the first and the second particles have an aspect ratio of at least 5 and at most 100, advantageously at least 20 and at most 100. The aspect ratio refers to the longest dimension of a particle divided by the mean thickness of the particle. The greater the aspect ratio, the flatter and flakier the particles are. Flaky mica particles typically have an aspect ratio which is greater than 4. At an aspect ratio of the first and the second particles of at least 5 and at most 100, the particles are sufficiently flat to be able to be processed in a simple manner into an electrical insulating paper. The flatter the first and the second particles are, the better they may be processed into an electrical insulating paper. Particles which have an aspect ratio of at least 20 and at most 100 are particularly suitable for the processing into an electrical insulating paper.

In one embodiment, a ratio of a mean particle size of the first particles to a mean particle size of the second particles is at least 3, advantageously at least 5. The mean particle size refers to the mean value of the distribution of the particle size, i.e., the longest dimension, of each particle within the group of the first or the second particles, respectively. Since the first or the second particles are not shaped identically to one another, the mean value of this distribution is a suitable parameter for comparing the particle size of the first particles to the particle size of the second particles. The ratio of the mean particle size of the first particles to the mean particle size of the second particles corresponds to the mean particle size of the first particles divided by the mean particle size of the second particles.

At a ratio of the mean particle size of the first particles to the mean particle size of the second particles of at least 3, the second particles are substantially smaller than the first particles. The second particles can thus be arranged particularly well between the first particles.

If the second particles are additionally provided in a sufficiently high volume proportion in relation to the electrical insulating paper that they form a network which connects the two opposing sides of the electrical insulating paper to one another, the second particles, if they are substantially smaller than the first particles, can form a particularly branched network in the electrical insulating paper. The network which is branched to a large extent and is made of the second particles results in a particularly large number of connections between the two opposing sides of the electrical insulating paper. A particularly high thermal conductivity of the electrical insulating paper is thus achieved.

In another embodiment, a ratio of a mean particle size of the first particles to a mean particle size of the second particles is 0.2-1.5, advantageously 0.2-0.8. At this ratio, the second particles are substantially of approximately equal size to or larger than the first particles. The second particles thus form a supporting mechanical network in the electrical insulating paper, by which the mechanical stability of the electrical insulating paper is increased. Conventional mica paper only has a low mechanical stability and tear resistance. For this reason, mica paper is further processed into more stable mica tapes, by applying it to a carrier. By way of the second particles, which are substantially of approximately equal size to or larger than the first particles, in contrast, it is possible to increase the mechanical stability and strength of the electrical insulating paper such that the application of the electrical insulating paper to a carrier can be omitted. The electrical insulating paper can therefore advantageously be used as such, i.e., without a carrier, in an electrical insulating body.

The second particles can comprise, for example, aluminum oxide, aluminum hydroxide, silicon dioxide, titanium dioxide, boron nitride, silicon nitride, and/or metal nitride, for example aluminum nitride.

In one embodiment, the second particles comprise aluminum oxide and/or boron nitride. Aluminum oxide and boron nitride have a particularly high thermal conductivity. Aluminum oxide has a thermal conductivity at 20° C. of 25-40 W/mK, for example 28 W/mK, and boron nitride has one of 100-1000 W/mK.

In one embodiment, the electrical insulating paper comprises a functionalizing agent, which increases attractive interactions between the second particles. The attractive interactions which form between the contact surfaces of adjacent particles include, for example, van der Waals forces and hydrogen bonds. It is possible that the second particles of their own accord only form weak attractive interactions with one another. The weak attractive interactions can limit the strength of the electrical insulating paper, however. The strength of the electrical insulating paper can be increased further by the use of a functionalizing agent which increases the attractive interactions between the second particles.

The functionalizing agent can form, for example, a thin film on the surface of the second particles and can enable coupling of the second particles by means of a chemical reaction, which takes place between the thin films.

A person skilled in the art can test in a simple manner whether an agent increases the attractive interactions between the second particles. For this purpose, a person skilled in the art produces electrical insulating papers with the agent and without the agent and compares the strength thereof. If the electrical insulating paper which has the agent displays a higher strength than the electrical insulating paper without the agent, then the agent is a functionalizing agent which increases attractive interactions between the second particles.

If the second particles comprise aluminum oxide, the functionalizing agent can be, for example, a polyolefin alcohol, in particular polyethylene glycol, or a not completely hydrolyzed polyvinyl alcohol having a molecular mass between 1000 and 4000, or a polyalkyl siloxane, in particular methoxy-terminated polydimethyl siloxane, or a silicone polyester, or an alkoxysilane. The alkoxysilane is advantageously selected such that it comprises epoxy groups, in particular 3-glycidoxypropyl trimethoxysilane, or amino groups, in particular 3-aminopropyl triethoxysilane.

In one embodiment, the electrical insulating paper comprises a functionalizing agent, which increases attractive interactions between the first particles. The strength of the electrical insulating paper can thus be increased further, as already described for the second particles.

In one embodiment, the electrical insulating paper comprises a functionalizing agent, which increases attractive interactions between the first and the second particles. This represents a further option for increasing the strength of the electrical insulating paper.

In a further aspect, the invention relates to a method for producing an electrical insulating paper. The method according to the invention comprises the following steps: mixing a dispersion made of first flaky particles, which comprise layered silicates, and of second flaky particles, which have a thermal conductivity at 20° C. of at least 1 W/mK, and a carrier fluid; producing a sediment by sedimentation of the dispersion, whereby the first and the second particles are arranged substantially in a layered and plane-parallel manner in the sediment; removing the carrier fluid from the sediment; and finishing the electrical insulating paper.

The first and the second particles advantageously have a mass proportion in the dispersion which is selected such that the electrical insulating paper has a porous structure and is therefore impregnable. The carrier fluid is, for example, water.

In the sediment, the first particles and the second particles are each arranged substantially in a layered and plane-parallel manner. Moreover, the first and the second particles are also arranged substantially in a layered and plane-parallel manner in relation to one another in the sediment.

The carrier fluid can be removed from the sediment, for example, by evaporation. The carrier fluid can also be removed by pouring the dispersion for producing the sediment onto a screen or a screening machine, suctioning off the carrier fluid, and subsequently drying the sediment. The drying can take place at a temperature of 20° C. or at higher temperatures, for example 110° C. to 180° C.

The finishing of the electrical insulating paper can comprise, for example, a compression of the electrical insulating paper to compact and/or smooth the electrical insulating paper.

It is ensured by the use of a dispersion in which the first and the second particles are provided simultaneously that the electrical insulating paper is formed both from the first particles and also from the second particles. An electrical insulating paper is thus produced which has a high partial discharge resistance and a high thermal conductivity.

Additional components, for example third particles, can be provided in the dispersion.

In a further aspect, the invention relates to an electrical insulating tape comprising the electrical insulating paper according to the invention and a carrier. The electrical insulating paper is applied to the carrier to improve the processability. The electrical insulating paper is advantageously adhesively bonded to the carrier. The carrier is advantageously not electrically conductive. The carrier is moreover advantageously porous, so that the electrical insulating tape is impregnable by an impregnating resin.

In one embodiment, the carrier is a knitted fabric, a nonwoven material, a foam, in particular an open-pored foam, a glass knitted fabric, a glass roving, a fabric, and/or a resin mat.

In a further aspect, the invention relates to an electrical insulating body comprising the electrical insulating paper according to the invention, wherein the electrical insulating paper is impregnated using an impregnating resin which comprises nanoscale and/or microscale inorganic particles, wherein the inorganic particles are in particular substantially spherical. The impregnating resin content of the electrical insulating body can be reduced and the thermal conductivity of the electrical insulating body can be further increased by the inorganic particles. Moreover, the inorganic particles increase the resistance of the electrical insulating body to electrical partial discharges.

In one embodiment, the inorganic particles of the impregnating resin comprise aluminum oxide, aluminum hydroxide, silicon dioxide, titanium dioxide, rare earth oxide, alkali metal oxide, and/or metal nitride, for example aluminum nitride. These materials are particularly suitable for the processing in the electrical insulating body, since they are not electrically conductive themselves. Moreover, particles which comprise the abovementioned materials are particularly resistant to high voltage.

In a further aspect, the invention relates to the use of the electrical insulating body according to the invention for electrically insulating current-conducting or potential-conducting components. The use is advantageous in particular in rotating electrical machines, for example generators and motors. In these machines, the main insulation also assumes the task of heat transportation, in addition to the electrical insulation. The high thermal conductivity of the electrical insulating body thus enables a high performance of the machines.

The use of the electrical insulating body according to the invention is also possible in transformers and power-electronic components.

The electrical insulating body according to the invention can also be used for the electrical isolation of conductive and/or semi-conductive elements, for example electrodes.

### BRIEF DESCRIPTION OF THE DRAWINGS

Embodiments of the electrical insulating tape according to the invention will be described hereafter on the basis of schematic drawings.

FIG. 1 shows a cross section of an impregnable electrical insulating paper according to an embodiment the invention.

FIG. 2 shows a cross section of an impregnable electrical insulating paper according to another embodiment the invention.

### DETAILED DESCRIPTION OF INVENTION

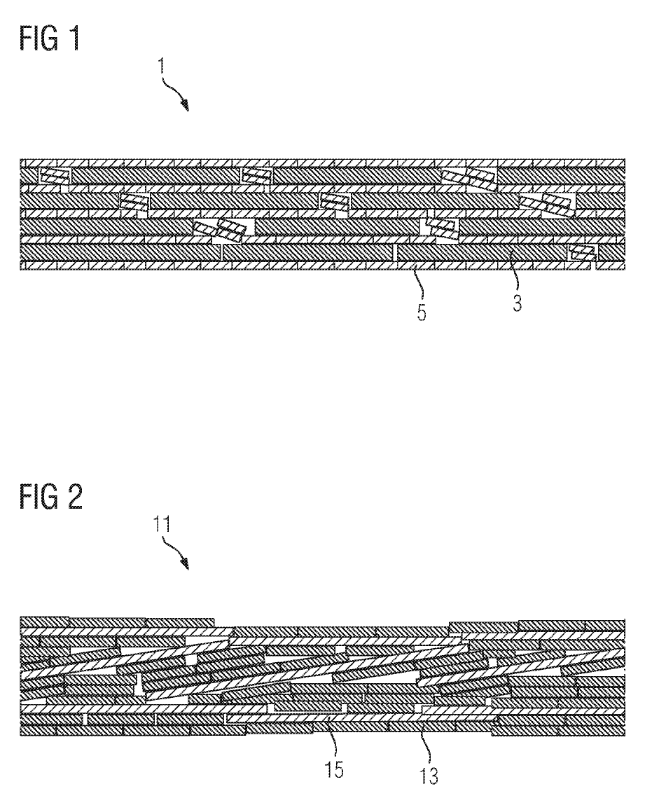

FIG. 1 shows a cross section of the impregnable electrical insulating paper 1 according to the invention. The electrical insulating paper 1 is porous and comprises mica particles 3 and aluminum oxide particles 5. The mica particles 3 have a mean particle size which is greater than a mean particle size of the aluminum oxide particles 5. The aluminum oxide particles 5 are therefore smaller than the mica particles 3. The aluminum oxide particles 5 are provided in a sufficiently high volume proportion in relation to the electrical insulating paper 1 that most of the aluminum oxide particles 5 are in touch contact with one or more further aluminum oxide particles 5. A network is thus formed from the aluminum oxide particles 5, which connects the two opposing broad sides of the electrical insulating paper 1 to one another. The electrical insulating paper 1 thus has a particularly high thermal conductivity.

FIG. 2 shows a cross section of the impregnable electrical insulating paper 11 according to the invention. The electrical insulating paper 11 is porous and comprises mica particles 13 and aluminum oxide particles 15. The mica particles 13 have a mean particle size which is less than the mean particle size of the aluminum oxide particles 15. The aluminum oxide particles 15 are therefore larger than the mica particles 13. The aluminum oxide particles 15 form a supporting mechanical network in the electrical insulating paper 11. The electrical insulating paper 11 thus has a high mechanical stability and a high strength.

1. An impregnable electrical insulating paper for an electrical insulating body, comprising:
first flaky particles, which comprise layered silicates, and
second flaky particles, which have a thermal conductivity at 20° C. of at least 1 W/mK.

2. The electrical insulating paper as claimed in claim 1,
wherein the second particles are provided in a sufficiently high volume proportion in relation to the electrical insulating paper that the second particles are in touch contact with one another and a network is thus formed from the second particles, which connects the two opposing sides of the electrical insulating paper to one another.

3. The electrical insulating paper as claimed in claim 1,
wherein the second particles are provided in a volume proportion in relation to the electrical insulating paper of 25-80 vol. %.

4. The electrical insulating paper as claimed in claim 1,
wherein the second particles are arranged on the two opposing sides of the electrical insulating paper and are in touch contact with one another, whereby a network is formed from the second particles on the two opposing sides of the electrical insulating paper.

5. The electrical insulating paper as claimed in claim 1,
wherein the thermal conductivity of the second particles at 20° C. is at least 10 W/mK.

6. The electrical insulating paper as claimed in claim 1,
wherein the second particles have a particle size of at least 5 μm and at most 150 μm.

7. The electrical insulating paper as claimed in claim 1,
wherein a ratio of a mean particle size of the first particles to a mean particle size of the second particles is at least 3.

8. The electrical insulating paper as claimed in claim 1,
wherein a ratio of a mean particle size of the first particles to a mean particle size of the second particles is 0.2-1.5.

9. The electrical insulating paper as claimed in claim 1,
wherein the second particles comprise aluminum oxide and/or boron nitride.

10. The electrical insulating paper as claimed in claim 1,
wherein the electrical insulating paper comprises a functionalizing agent which increases attractive interactions between the second particles.

11. A method for producing an electrical insulating paper, comprising:
mixing a dispersion made of first flaky particles, which comprise layered silicates, and of second flaky particles, which have a thermal conductivity at 20° C. of at least 1 W/mK, and a carrier fluid;
producing a sediment by sedimentation of the dispersion, whereby the first and the second particles are arranged substantially in a layered and plane-parallel manner in the sediment;
removing the carrier fluid from the sediment; and
finishing the electrical insulating paper.

12. An electrical insulating tape comprising:
an electrical insulating paper as claimed in claim 1, and a carrier.

13. An electrical insulating body comprising:
an electrical insulating paper as claimed in claim 1, wherein the electrical insulating paper is impregnated using an impregnating resin which comprises nanoscale and/or microscale inorganic particles.

14. The electrical insulating body as claimed in claim 13,
wherein the inorganic particles of the impregnating resin comprise aluminum oxide, aluminum hydroxide, silicon dioxide, titanium dioxide, rare earth oxide, alkali metal oxide, and/or metal nitride.

15. A method of electrically insulating components, comprising:
electrically insulating current-conducting or potential-conducting components using an electrical insulating body as claimed in claim 13.

16. The electrical insulating paper as claimed in claim 3,
wherein the second particles are provided in a volume proportion in relation to the electrical insulating paper of 50-80 vol. %.

17. The electrical insulating paper as claimed in claim 5,
wherein the thermal conductivity of the second particles at 20° C. is at least 25 W/mK.

18. The electrical insulating paper as claimed in claim 7,
wherein a ratio of a mean particle size of the first particles to a mean particle size of the second particles is at least 5.

19. The electrical insulating paper as claimed in claim 8,
wherein a ratio of a mean particle size of the first particles to a mean particle size of the second particles is 0.2-0.8.

20. The electrical insulating body as claimed in claim 13,
wherein the electrical insulating paper is impregnated using an impregnating resin which comprises nanoscale and/or microscale inorganic particles, wherein the inorganic particles are substantially spherical.
